(19) United States
(12) Patent Application Publication
(10) Pub. No.: US 2012/0138007 A1
(43) Pub. Date: Jun. 7, 2012

(54) CYLINDER HEAD WITH PLURAL COOLING JACKETS HAVING CAST-IN CONNECTING ORIFICES, METHOD OF FABRICATING THE CYLINDER HEAD, AND CASTING CORE ASSEMBLY FOR FABRICATING A CYLINDER HEAD

(75) Inventors: Matthew Giles SMITH, Darlington (GB); Stephen SAXBY, Beijing (CN); Jerl PURCELL, Louisa, VA (US); John ANDERSON, Thirsk (GB)

(73) Assignee: CUMMINS INTELLECUTAL PROPERTIES, INC., Minneapolis, MN (US)

(21) Appl. No.: 13/178,466

(22) Filed: Jul. 7, 2011

Related U.S. Application Data
(60) Provisional application No. 61/362,051, filed on Jul. 7, 2010.

(51) Int. Cl. F02F 1/26; B22D 25/02

(52) U.S. Cl. 123/193.5; 164/137; 164/271

(57) ABSTRACT

This disclosure provides a cast cylinder head includes two cooling jackets for use with an internal combustion engine, a method of fabricating a cylinder head, and a casting core assembly for fabricating a cylinder head. The cast cylinder head includes at least one cast-in orifice, which fluidly connects the two cooling jackets and is formed during a casting process of the cylinder head. The method of fabricating a cylinder head includes utilizing an assembly including an upper cooling jacket core and a lower cooling jacket core for forming respective upper and lower cooling jackets and at least one cast-in orifice fluidly connecting the cooling jackets.

### CROSS REFERENCE TO RELATED APPLICATIONS

This application claims benefit of priority to Provisional Patent Application No. 61/362,051, filed on Jul. 7, 2010, the entire contents of which are hereby incorporated by reference.

### FIELD OF THE INVENTION

The invention relates a cylinder head including plural cooling jackets for use with an internal combustion engine, a method of fabricating a cylinder head, and a casting core assembly for fabricating a cylinder head, and more particularly, to a cylinder head and method of fabricating a cylinder head including an upper cooling jacket fluidly connected to a lower cooling jacket via a cast-in orifice, and to a core assembly for fabricating a cylinder head having upper and lower cooling jackets fluidly connected via a cast-in orifice.

### BACKGROUND

Cylinder heads of internal combustion engines include a number of cavities called water jackets, or cooling jackets through which coolant (e.g., water) flows to provide vital cooling to the intake and exhaust ports, valve guide features, valve seats, and combustion deck of the cylinder head. FIG. 1A is a simplified diagram of a conventional cylinder head 1 for an internal combustion engine having a liquid coolant system. The liquid coolant system includes a lower cooling jacket 2a separated from an upper cooling jacket 2b by material 3 of the cylinder head 1 (e.g., cast iron or aluminum). The cylinder head material 3 also defines other peripheral confines of the lower/upper cooling jackets 2a, 2b. The lower cooling jacket 2a includes inlet orifices 12a to 12d that are in fluid communication with engine block water (cooling) jackets of an internal combustion engine (not shown). The cylinder head passages include the cooling jackets 2a, 2b to allow heat transfer from the cylinder head material 3 and other cylinder head components to liquid coolant 10 flowing through the cylinder head 1.

As shown by arrow 13 in FIG. 1A, coolant 10 flowing from the engine block cooling jackets enters the lower cooling jacket 2a through the orifices 12 to 12d and flows generally across the cooling jacket 2a toward machined orifices 14a to 14d, which provide fluid communication between the lower cooling jacket 2a and the upper cooling jacket 2b.

### SUMMARY

This disclosure provides a cast cylinder head includes two cooling jackets for use with an internal combustion engine, a method of fabricating a cylinder head, and a casting core assembly for fabricating a cylinder head. The cast cylinder head includes at least one cast-in orifice, which is formed during a casting process of the cylinder head and fluidly connects the two cooling jackets. The method of fabricating a cylinder head includes utilizing an assembly including an upper cooling jacket core and a lower cooling jacket core for forming the cooling jackets and a cast-in orifice fluidly connecting the cooling jackets.

In one aspect of the disclosure, a method of fabricating a cylinder head for an internal combustion engine includes providing a mold cavity including pattern features for defining outer surfaces of a cylinder head, inserting into the molding cavity an upper cooling jacket core for forming an upper cooling jacket in the cylinder head, inserting into the molding cavity a lower cooling jacket core for forming a lower cooling jacket in the cylinder head, and pouring liquid metal into the mold cavity including the upper and lower cores to substantially surround the upper and lower cooling jacket cores to form respective upper and lower cooling jackets. At least one of the upper and lower cooling jacket cores includes at least one projecting member including a distal surface. With the upper and lower cooling jacket cores inserted into the mold cavity just prior to providing the molten metal, the distal surface of each projecting member is provided adjacent a corresponding complementary surface of the other of the upper and lower cores to form a cast-in passage from the molten metal between upper and lower cooling jackets in the cylinder head.

In another aspect of the disclosure, a cooling jacket casting core assembly for a cylinder head for an internal combustion engine includes a first cooling jacket casting core having an impression of a cylinder head cooling jacket and a second cooling jacket casting core having an impression of a cylinder head cooling jacket. One of the first cooling jacket casting core and the second cooling jacket casting core includes a projecting member having a distal surface and the other of the first cooling jacket casting core and the second cooling jacket casting core includes a complementary surface that directly faces the distal surface with assembly of the first and second cooling jacket cores for inserting into a molding cavity for forming a cylinder head.

In yet another aspect of the disclosure, a cast cylinder head having plural cylinder portions for an internal combustion engine including plural cylinders has a combustion surface including the plural cylinder portions, a lower cooling jacket forming a cavity over the combustion surface, an upper cooling jacket forming a cavity over the lower combustion surface, at least one cast-in orifice forming a fluid passageway between the upper cooling jacket and the lower cooling jacket. The cast-in orifice is formed in a casting process in which the cylinder head is cast.

Other features, elements, characteristics and advantages will become more apparent from the following detailed description with reference to the attached drawings.

### BRIEF DESCRIPTION OF THE DRAWINGS

FIG. 1A is a diagram of a conventional cylinder head including upper and lower water passages.

FIG. 1B is a diagram of a cylinder head portion as seen in plan view from the combustion surface side and showing areas that should not be machined to fluidly connect cooling jackets.

FIG. 2 is a diagram of a cast cylinder head including upper and lower cooling jackets according to an exemplary embodiment.

FIG. 3 is a diagram of a cooling jacket core assembly according to an exemplary embodiment, which can be used to form cooling jackets and cast-in passages in a cylinder head of an internal combustion engine.

### DETAILED DESCRIPTION

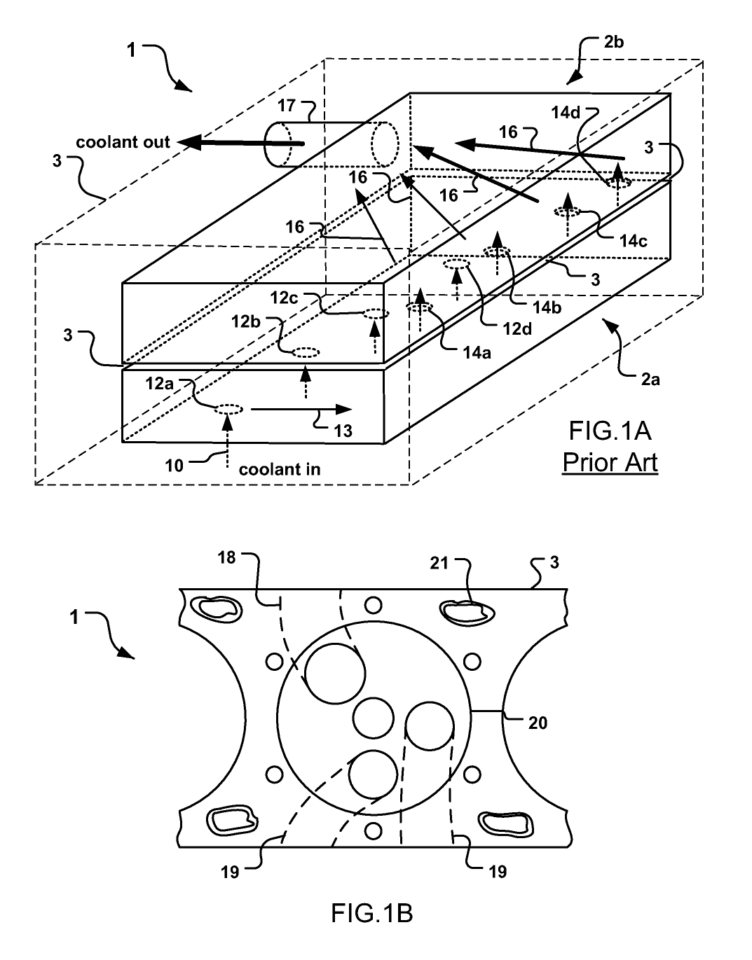

The inventors realized that in the conventional cylinder head 1, after coolant enters the upper cooling jacket 2b, a majority of coolant 10 tends to flow in a longitudinal direction towards the coolant outlet 17. For example, in the cylinder head 1 shown in FIG. 1A, coolant 10 supplied by a water pump (not shown) flows from the engine block cooling jackets (not shown), enters the lower cooling jacket 2a through the orifices 12a to 12d, and thereafter generally flows across the cooling jacket 2a along paths in the direction shown by arrow 13 (i.e., left-to-right in the orientation depicted in FIG. 1A) toward orifices 14a to 14d, which fluidly communicate with the upper cooling jacket 2b. The coolant 10 then passes through each of the orifices 14a to 14d and enters the upper cooling jacket 2b. However, after entering the upper cooling jacket 2b, a majority of the coolant 10 flowing from the orifices 14a to 14d tends to flow in a longitudinal direction of the cylinder head (i.e., a direction from the rear to the front of the engine) towards the coolant outlet passage 17, as illustrated by plural arrows 16, resulting in areas in the upper cooling jacket 2b, and correspondingly also in the lower cooling jacket 2a, where there is little or no coolant flow relative to other areas of the cooling jackets 2a, 2b. As a consequence to this non-uniformity, a temperature differential can exist across portions of the cylinder head 1 having the differential coolant flow. This can adversely affect a cylinder head by stressing the cylinder head material over a number of operating cycles to a point where the cylinder head cracks and/or distorts. Additionally, engine efficiency, durability, and/or reliability can be adversely affected when one or more of the cylinder head components, such as intake ports, exhaust ports, valve seats are not properly cooled.

FIG. 1B is a diagram showing a portion of a combustion side of a cylinder head 1. While upper and lower cooling jackets of a cylinder head can be fluidly connected by way of machining a cylinder head, such machining often involves complicated and expensive processes, such as angled drilling processes. As shown in FIG. 1B, placement of these machined orifices is limited to avoiding drilling, for example, access holes in areas including intake ports 18, exhaust ports 19, inside the combustion chambers 20, areas of oil or coolant transfer 20, and/or any area of high thermal stress on the combustion face of the cylinder head 1.

Exemplary embodiments of the disclosure include a two-piece water (cooling) jacket design, where cooling jackets fluidly communicate with each other via cast-in orifices. The cast-in connection facilitates creation of a cylinder head having increased torsional stiffness, improved core stability, and improved wall thickness control. This allows control of the coolant flow laterally as well as longitudinally throughout the volumes of two cooling jackets of the cylinder head for improved coolant control. By having cast-in orifices, the water flow can be controlled more accurately because the position, size and/or shape of the orifices is not limited by the machinist's ability to machine the hole.

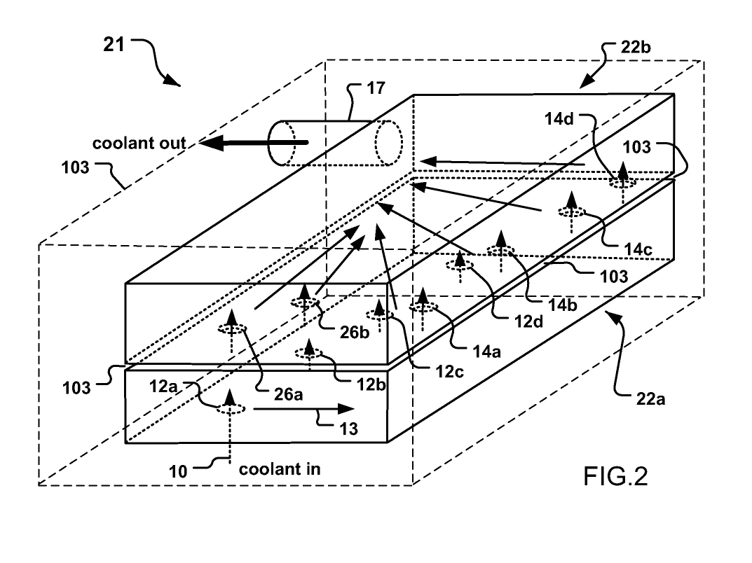

FIG. 2 shows a simplified diagram of a coolant passage system for a cylinder head 21 according to an exemplary embodiment. Items having the reference numbers used in FIG. 1A are described above. As shown in FIG. 2, the coolant passage system includes two passages, or orifices 26a and 26b fabricated in a casting process in area of cylinder head material 103 between a lower cooling jacket 22a and an upper cooling jacket 22b, although only one or more than two cast-in orifices may be provided between cooling jackets.

The cast-in passages 26a and 26b can be provided in any area of the cylinder head material 3 that would be required for more uniform coolant flow, rather than only in areas which are accessible for drilling. For instance, an orifice can be provided near air induction ports of the cylinder head, for example, in portions of the head underneath and/or beside the induction ports, which are not accessible via a drilling process. Additionally, a cast-in orifice can be formed using core material, for example, sand core that is shaped and/or sized and positioned to tailor an amount of coolant flow between the lower cooling jacket 22a and upper cooling jacket 22b. Thus, a fluid passageway, or fluid connection between cylinder head cooling jackets made by a casting process can provide a flexible way to control coolant flow via control of the size, shape, and/or position of an orifice in one or more areas of a cylinder head.

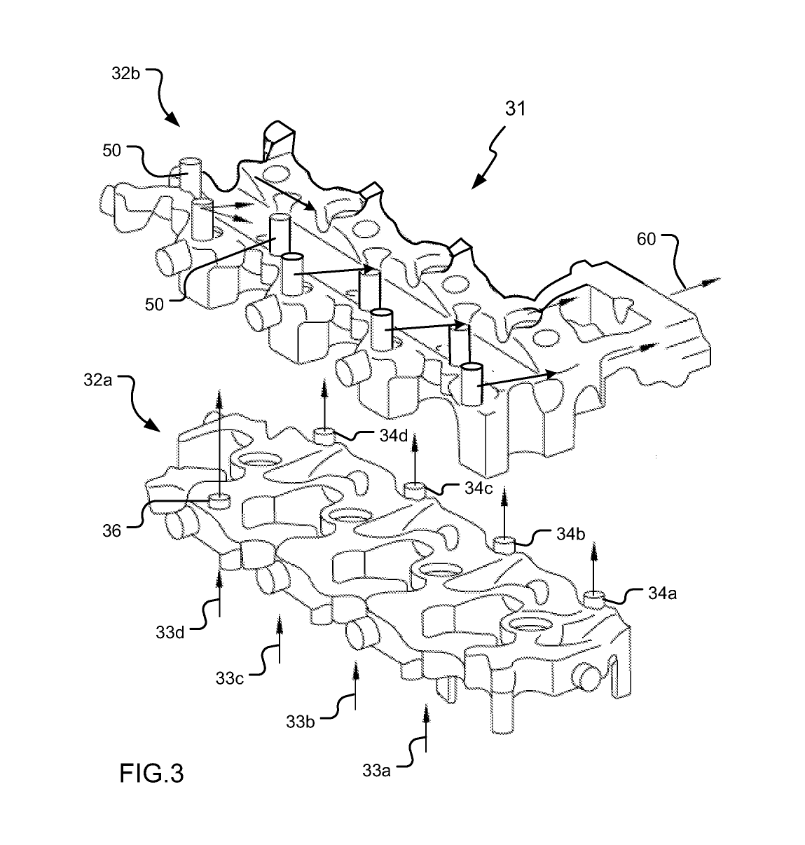

FIG. 3 shows an exemplary embodiment of a cooling jacket core system 31 that can be used in combination to form a cylinder head having upper and lower cooling jackets and at least one cast-in orifice therebetween. As show in FIG. 3, a lower core section 32a and an upper core section 32b can be used to form a lower cooling jacket cavity in a cylinder head for coolant to flow. The lower core section 32a has extensions that protrude from the underside of the depicted portion 32a to an extent of a surface that includes the combustion chambers of a cylinder head formed using the core system 31 (not shown). These extensions provide coolant passages from the engine block cooling jackets to the lower cooling jacket when a cylinder head is mated with the surface of the engine block to seal a bank of cylinders. The lower core section 32a and the upper core section 32b each include an impression of a cooling jacket and generally have a longitudinal shape in that they form cavities that extend along most of the longitudinal length of the cylinder head.

On an upper side of the lower core section 32, casting orifices 34a to 34d extend in an outward direction and are provided adjacent surfaces of the upper core section 32b. In an embodiment, the casting orifices 34a to 34d of the lower core section 32a can be fastened to one another, for example, adhered by gluing at least one surface of the upper core section 32b to a surface of the lower core section where a cast-in orifice will be formed to allow coolant to enter the upper core section 32b from the lower core section 32a. A surface to be fastened can include a projection of a desired cross-sectional shape, e.g., one or more cylindrically-shaped projections, which extend from one of the cooling jackets to contact a surface of the other cooling jacket. In this way, a cast-in orifice or passageway can be formed between upper and lower cooling jackets of a cylinder head.

Rather than using some kind of adhesive, the upper and lower core sections can be assembled using an assembly screw or some other kind of fastener. In another embodiment, the core sections 32a, 32b can be clamped or otherwise held into position within a molding box (not shown). Embodiments can include any one or any combination of these techniques to joining or abutting the core sections prior to casting, which can provide core stability and improved wall thickness control during the casting process.

In the exemplary core system 31 shown in FIG. 3, each of the casting orifices 34a to 34d forms a male part and the upper core section 32b includes a corresponding complementary surface, such as a female part or complementary abutting surface that are joined together and placed in, or inserted into a molding box, or molding cavity. Alternatively, also shown in FIG. 3 is an extension portion 36, which can represent an orifice for providing a fluid connection between the lower/upper core sections 32a/32b and/or a stabilizing structure for the core system 31. The top side of upper core section 32b includes stabilizing extensions 50 (only two of which are labeled in FIG. 3), and similar extensions at the side of the lower/upper core sections 32a/32b to stabilize and support the core system 31 in molding box and/or serve as “freeze plug” orifices of a cylinder head. The upper core section 32b includes a portion 60 that provides a coolant flow outlet in the cylinder head, for example, to a thermostat unit or housing.

Although the extension portion 36 is shown in FIG. 3 as a cylindrically-shaped projection having a distal surface facing the upper cooling cavity core portion, an extension can be formed into another regular or irregular shape. One or more such projections can be provided on the upper cooling jacket core, on only the lower cooling jacket core, or on both the upper and lower cooling jacket cores. When assembled together prior to pouring liquefied metal into the molding cavity, each distal surface of a projecting member abuts its corresponding complementary surface to form a cast-in passage between upper and lower cooling jackets in the cylinder head from molten metal poured into the molding cavity.

While not shown, other core elements can be included in the molding cavity to form cavities corresponding to other cylinder head components, such as induction and exhaust ports. For example, an embodiment can include inserting induction port cores into the mold cavity along with the upper and lower cooling jacket cores. At least one adjacent distal surface and corresponding complementary surface can be positioned in a portion of the cylinder head mold cavity underneath and/or beside induction ports when viewed in plan view from a side of the mold cavity forming the combustion surface of the cylinder head. As described above, placement of a fluid passageway underneath and/or beside induction ports would not have been possible because these areas are not accessible via a conventional drilling process.

Embodiments consistent with the disclosure can provide a cylinder head having increased structural robustness because they reduce or eliminate the need to drill holes into the cylinder head walls to access one of cooling jackets. For example, machining a cylinder head can include drilling an access hole or point through the cylinder head surface at a portion bearing a significant load to access the interior of one of the two cooling jackets in the head. Thereafter, a second hole is drilled through a section of the cylinder head between the two cooling jackets to provide a fluid communication path between the cooling jackets, and the access hole is thereafter plugged to contain coolant in the cooling jacket cavities. However, the first drilled access hole, and possibly the second drilled hole through a load-bearing portion can weaken the cylinder head structure, thus making the head more prone to cracking. A cast-in orifice according to embodiments of the disclosure can reduce or eliminate drilling through significant load bearing portions of the head because the cast-in orifice can be formed in any available area between the cooling jackets. Furthermore, in addition to providing a path for coolant flow between cooling jacket sections in a cylinder head, the cast-in orifice structures of the core system can provide stability and support of the upper and lower core sections while in the mold, and thus can reduce or eliminate the need for these support/stability structures.

Although a limited number of embodiments is described herein, one of ordinary skill in the an will readily recognize that there could be variations to any of these embodiments and those variations would be within the scope of the appended claims. Thus, it will be apparent to those skilled in the art that various changes and modifications can be made to the cylinder head, method of fabricating a cylinder head, and core system described herein without departing from the scope of the appended claims and their equivalents.

What is claimed is:

1. A method of fabricating a cylinder head for an internal combustion engine, comprising:
providing a mold cavity including pattern features for defining outer surfaces of a cylinder head;
inserting into the molding cavity an upper cooling jacket core for forming an upper cooling jacket in the cylinder head;
inserting into the molding cavity a lower cooling jacket core for forming a lower cooling jacket in the cylinder head; and
pouring molten metal into the mold cavity including the upper and lower cores to substantially surround the upper and lower cooling jacket cores to form respective upper and lower cooling jackets, wherein
at least one of the upper and lower cooling jacket cores includes at least one projecting member including a distal surface, and with the upper and lower cooling jacket cores inserted into the mold cavity just prior to providing the molten metal, the distal surface of each projecting member is adjacent a corresponding complementary surface of the other of the upper and lower cores to form a cast-in passage from the molten metal between upper and lower cooling jackets in the cylinder head.

2. The method according to claim 1, further comprising assembling the upper cooling jacket core and the lower cooling jacket core prior to inserting the assembled upper and lower cooling jackets into the mold cavity.

3. The method according to claim 2, wherein assembling comprises fastening the upper cooling jacket core to the lower cooling jacket core such that each said distal surface is adjacent said corresponding complementary surface.

4. The method according to claim 1, further comprising inserting induction port cores into the mold cavity, wherein the at least one adjacent distal surface and corresponding complementary surface is positioned in a portion of the cylinder head underneath and/or beside the induction ports cores when viewed in plan view from a side of the mold cavity forming the combustion surface of the cylinder head.

5. A cooling jacket casting core assembly for a cylinder head for an internal combustion engine, comprising:
a first cooling jacket casting core having an impression of a cylinder head cooling jacket; and
a second cooling jacket casting core having an impression of a cylinder head cooling jacket, wherein
one of the first cooling jacket casting core and the second cooling jacket casting core includes a projecting member having a distal surface and the other of the first cooling jacket casting core and the second cooling jacket casting core includes a complementary surface for directly facing the distal surface with assembly of the first and second cooling jacket cores for inserting into a molding cavity for forming a cylinder head.

6. The cooling jacket casting core assembly according to claim 5, wherein the complementary surface abuts the distal surface with assembly of the first and second cooling jacket cores.

7. The cooling jacket casting core assembly according to claim 5, wherein the complementary surface and the distal surface form a male and female pair with assembly of the first and second cooling jacket cores.

8. The cooling jacket casting core assembly according to claim 5, wherein each of the first and second cooling jacket cores is longitudinally-shaped.

9. The cooling jacket casting core assembly according to claim 5, wherein plural pairs of said projecting members having a distal surface and said corresponding complementary surface are positioned along a first longitudinal side of the assembly.

10. The cooling jacket casting core assembly according to claim 9, wherein at least one pair of said projecting member having a distal surface and said corresponding complementary surface are positioned along a second longitudinal side of the assembly opposite the first longitudinal side.

11. A cast cylinder head having plural cylinder portions for an internal combustion engine including plural cylinders; comprising:
a combustion surface including the plural cylinder portions;
a lower cooling jacket forming a cavity over the combustion surface;
an upper cooling jacket forming a cavity over the lower combustion surface; and
at least one cast-in orifice forming a fluid passageway between the upper cooling jacket and the lower cooling jacket, said cast-in orifice formed in a casting process in which the cylinder head is cast.

12. The cast cylinder head of claim 11, wherein each of the lower cooling jacket and the upper cooling jacket extends along extends along substantially the entire longitudinal length of the cylinder head.

13. The cast cylinder head of claim 11, wherein the cast-in orifice is positioned in a portion of the cylinder head underneath and/or beside the induction ports cores when viewed in plan view from the combustion surface side of the cylinder head.

14. The cast cylinder head of claim 11, wherein plural said cast-in orifices form fluid passageways between the upper cooling jacket and the lower cooling jacket.

15. The cast cylinder head of claim 14, wherein at least one of said plural cast-in orifices is positioned along a first longitudinal side of the cylinder head, along which having orifices are positioned on combustion surface for the fluidly connecting the lower cooling jacket with cooling jackets of the engine block.

16. The cast cylinder head of claim 15, wherein plural said cast-in orifices are positioned along a second longitudinal side of the cylinder head opposite the first longitudinal side.
